(19) United States
(12) Patent Application Publication
(10) Pub. No.: US 2025/0356402 A1
(43) Pub. Date: Nov. 20, 2025

(54) POINT OF DELIVERY RETAIL KIOSK SYSTEM

(71) Applicant: International Vending Management, Inc., Indianapolis, IN (US)

(72) Inventors: Wayne Bender, Seymour, IN (US); Jeffrey Gabonay, Noblesville, IN (US); James Nathan Guffey, Greencastle, IN (US); William Ott, Indianapolis, IN (US); Michael Pitts, Fishers, IN (US); Grant Gillespie, Brownsburg, IN (US); William Lynch, Indianapolis, IN (US)

(73) Assignee: International Vending Management, Inc., Indianapolis, IN (US)

(21) Appl. No.: 19/208,814

(22) Filed: May 15, 2025

Related U.S. Application Data
(60) Provisional application No. 63/648,383, filed on May 16, 2024.

(51) Int. Cl. G06Q 30/0601; G07C 9/00

(52) U.S. Cl. CPC G06Q 30/0601; G07C 9/00896

(57) ABSTRACT

A point of delivery retail kiosk system for vending products includes a plurality of lockers, at least one kiosk, and a controller. Each of the plurality of lockers containing a product therein. The at least one kiosk includes a user interface and a scanner configured to scan at least one code. The controller is in communication with each of the plurality of lockers and the at least one kiosk.

### CROSS-REFERENCE TO RELATED APPLICATIONS

This application claims the benefit of U.S. patent application No. 63/648,383, filed May 16, 2024, which is expressly incorporated by reference herein.

### TECHNICAL FIELD

The present disclosure relates to a kiosk system, and in particular, to a point of delivery retail kiosk system. More specifically, the present disclosure relates to a point of delivery retail kiosk system including at least one kiosk and a plurality of lockers.

### SUMMARY

The present disclosure includes one or more of the features recited in the appended claims and/or the following features which, alone or in any combination, may comprise patentable subject matter.

According to the present disclosure, a method of operating a retail kiosk system may be provided. The method may comprise providing a plurality of lockers and at least one kiosk in communication with each of the plurality of lockers, each of the plurality of lockers including a product therein. The method may comprise retrieving a product list based on at least one code scanned by the at least one kiosk. The method may comprise determining a locker location of each product on the product list. The method may comprise generating a pickup sequence associated with the product list based, at least in part, on the locker location of each product on the product list and, at least in part, on a category of each product on the product list. The method may comprise based on the pickup sequence, opening a first locker of the plurality of lockers. The method may comprise determining that the product in the first locker has been removed from the first locker. The method may comprise, in response to determining that the product in the first locker has been removed, opening a second locker of the plurality of lockers.

Optionally, the method may further comprise displaying the pickup sequence on a user interface of the at least one kiosk. The step of opening a first locker may include changing a first indicator included on the first locker to a first visual representation from a second visual representation different than the first visual representation to indicate that the first locker is open.

Further optionally, the step of opening a second locker may include changing the first indicator included on the first locker to the second visual representation and changing a second indicator included on the second locker to a third visual representation from a fourth visual representation different than the third visual representation to indicate that the second locker is open. The method may further comprise determining that the product in the second locker has been removed from the second locker, and in response to determining that the product in the second locker has been removed, opening a third locker of the plurality of lockers. The category of each product may include at least one of a weight, a size, and a cost.

If desired, the step of retrieving a product list based on at least one code may include retrieving the product list based on two different codes. The method may further comprise changing a kiosk indicator included on the at least one kiosk to a first visual representation from a second visual representation different than the first visual representation to indicate that the at least one kiosk is available for use. The first visual representation may be an illuminated green light.

Further according to the present disclosure, a point of delivery retail kiosk system for vending products may be provided. The system may comprise a plurality of lockers, at least one kiosk, and a controller. Each of the plurality of lockers may include a body formed to include an aperture opening into an interior product storage region, a door coupled to the body to close the aperture, and a lock configured to release selectively the door from the body to open the aperture. Each of the plurality of lockers may contain a product therein. The at least one kiosk may include a user interface and a scanner configured to scan at least one code. The controller may be in communication with each of the plurality of lockers and the at least one kiosk. The controller may be configured to retrieve a product list based on the at least one code scanned by the scanner of the at least one kiosk and output a pickup sequence associated with the product list to be implemented by the plurality of lockers. The pickup sequence may be based, at least in part, on a locker location of each product on the product list and, at least in part, on a category of each product on the product list so that the pickup sequence is optimized based on the locker location of each product and the category of each product on the product list thereby allowing the plurality of lockers to be sequentially opened based on the pickup sequence in an optimized manner.

Optionally, the controller may be configured to determine the locker location of each product on the product list for use in determining the pickup sequence. Each of the plurality of lockers may include a sensor in communication with the controller and configured to indicate when the product in the respective locker is removed from the respective locker. Each of the plurality of lockers associated with the pickup sequence may be opened sequentially such that a second locker of the plurality of lockers is not opened until the sensor of a first locker in the plurality of lockers indicates that the product in the first locker is removed from the first locker. The pickup sequence may be displayed on the user interface of the at least one kiosk.

Further optionally, each of the plurality of lockers may include an indicator that changes between a first visual representation and a second visual representation different than the first visual representation. The first visual representation may be an illuminated light. The category of each product may include at least one of a weight, a size, and a cost. The at least one kiosk may include a kiosk indicator that changes between a first visual representation and a second visual representation different than the first visual representation to indicate that the at least one kiosk is available or unavailable for use. The first visual representation may be an illuminated green light. The lock of each of the plurality of lockers may be configured to release the respective door from the respective body in response to a signal received from the controller to allow a user to access the interior product storage region.

Further according to the present disclosure a controller is provided. The controller may comprise a processor and a memory. The memory may have instructions stored therein executable by the processor to cause the processor to (a) retrieve a product list based on at least one scanned code, (b) determine a location of each product on the product list, (c) determine a pickup sequence associated with the product list, the pickup sequence based, at least in part, on the location of each product on the product list and, at least in part, on a category of each product on the product list, and (c) output the pickup sequence.

Optionally, the instructions stored in the memory may further include instructions executable by the processor to cause the processor to control a plurality of lockers such that the plurality of lockers are sequentially opened based on the pickup sequence in an optimized manner. The instructions stored in the memory may further include instructions executable by the processor to cause the processor to open a first locker of the plurality of lockers based on the pickup sequence. The instructions stored in the memory may further include instructions executable by the processor to cause the processor to determine that the product in the first locker has been removed from the first locker. The instructions stored in the memory may further include instructions executable by the processor to cause the processor to, in response to determining that the product in the first locker has been removed, open a second locker of the plurality of lockers.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a diagrammatic view of a point of delivery retail kiosk system including at least one kiosk, a plurality of lockers, and a controller in communication with each of the plurality of lockers and the at least one kiosk, the controller configured to sequentially open the plurality of lockers so that a user can access products therein;

FIG. 2 is a diagrammatic view of the point of delivery retail kiosk system of FIG. 1 showing that a first locker of the plurality of lockers is open so that the user can access the product therein;

FIG. 3 is a diagrammatic view of the point of delivery retail kiosk system of FIG. 1 showing that a second locker of the plurality of lockers is open after the product in the first locker is retrieved by the user so that the user can access the product in the second locker;

FIG. 4 is a diagrammatic view showing a process of using the point of delivery retail kiosk system of FIG. 1; and

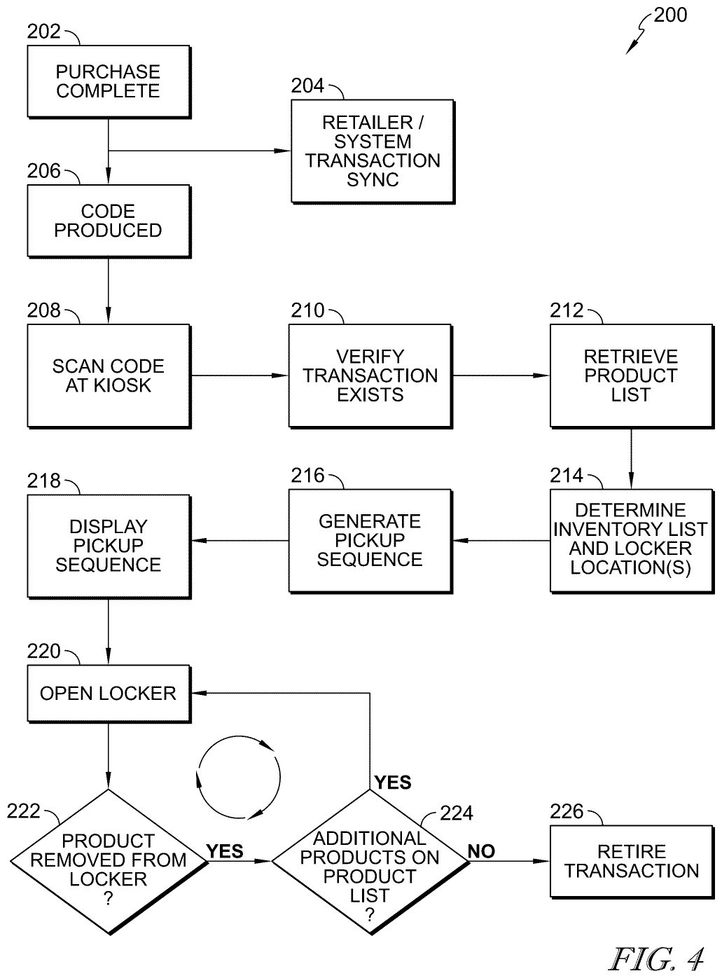

FIG. 5 is a diagrammatic view of a control system of the point of delivery retail kiosk system of FIG. 1.

### DETAILED DESCRIPTION

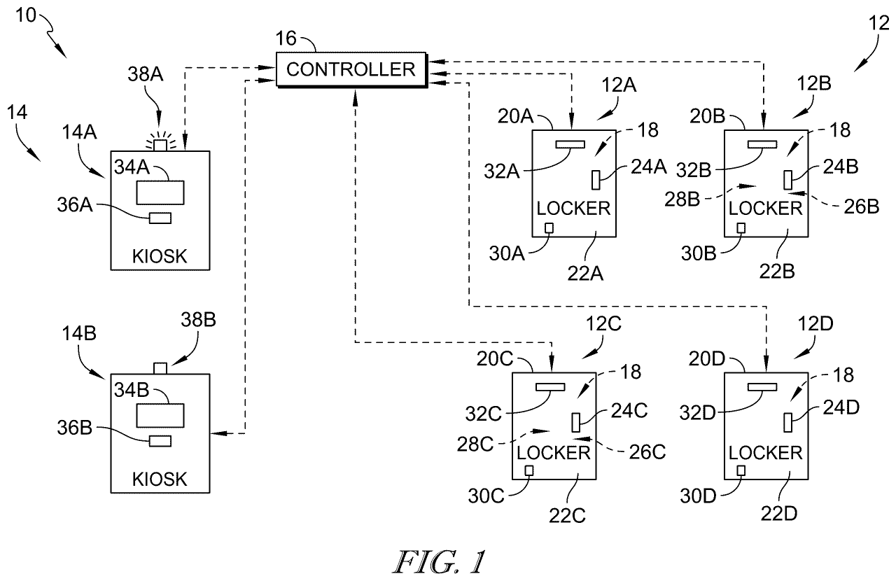

A point of delivery retail kiosk system 10 in accordance with the present disclosure includes a plurality of lockers 12, at least one kiosk 14, and a controller 16, as shown in FIGS. 1-3. The retail kiosk system 10 allows users to retrieve purchased products 18 stored within the plurality of lockers 12. The retail kiosk system 10 provides a convenient and safe way to retrieve purchased products 18, either after checkout in a retail store or after an online order is made. The retail kiosk system 10 is located in a pickup location, which may be in a retail store or separate from the retail store. The user, either after checkout or after an online order is made, uses the self-service kiosk 14 to retrieve the purchased products 18 without waiting in line or waiting for a retail associate to assist.

The plurality of lockers 12 includes, for example, a first locker 12A, a second locker 12B, a third locker 12C, and a fourth locker 12D, as shown in FIGS. 1-3. Though shown with four lockers 12A, 12B, 12C, 12D, the plurality of lockers 12 may include any number of lockers 12. The plurality of lockers 12 may be made in a variety of sizes to fit variously sized products 18. Each of the plurality of lockers 12 is stocked with a product 18 therein.

Each of the plurality of lockers 12 includes a body 20A, 20B, 20C, 20D, a door 22A, 22B, 22C, 22D, and a lock 24A, 24B, 24C, 24D, as shown in FIGS. 1-3. The body 20A, 20B, 20C, 20D is formed to include an aperture 26A, 26B, 26C, 26D opening into an interior product storage region 28A, 28B, 28C, 28D. A product 18 is received in the interior product storage region 28A, 28B, 28C, 28D of each of the plurality of lockers 12. The door 22A, 22B, 22C, 22D is coupled to the body 20A, 20B, 20C, 20D to close the aperture 26A, 26B, 26C, 26D such that the interior product storage region 28A, 28B, 28C, 28D (and thus, the product 18 therein) is not accessible to the user. The lock 24A, 24B, 24C, 24D is configured to release selectively the door 22A, 22B, 22C, 22D from the body 20A, 20B, 20C, 20D to open the aperture 26A, 26B, 26C, 26D and allow access to the interior product storage region 28A, 28B, 28C, 28D (and thus, the product 18 therein). In some embodiments, the door 22A, 22B, 22C, 22D is hingedly attached to the body 20A, 20B, 20C, 20D. The lock 24A, 24B, 24C, 24D of each of the plurality of lockers 12 is configured to release the door 22A, 22B, 22C, 22D from the body 20A, 20B, 20C, 20D in response to a signal received from the controller 16 to allow the user to access the interior product storage region 28A, 28B, 28C, 28D.

Each of the plurality of lockers 12 includes a sensor 30A, 30B, 30C, 30D in communication with the controller 16, as shown in FIGS. 1-3. The sensor 30A, 30B, 30C, 30D is configured to detect, determine, and/or indicate when the product 18 in the locker 12A, 12B, 12C, 12D is removed from the locker 12A, 12B, 12C, 12D. In some embodiments, the sensor 30A, 30B, 30C, 30D detects and/or determines whether the product 18 has been removed from the interior product storage region 28A, 28B, 28C, 28D. In some embodiments, the sensor 30A, 30B, 30C, 30D detects and/or determines whether the door 22A, 22B, 22C, 22D of the locker 12A, 12B, 12C, 12D has been closed (i.e., closed by the user after the user has retrieved the product 18 therein). In some embodiments, the sensor 30A, 30B, 30C, 30D detects and/or determines whether a button has been actuated by the user indicating that the user has retrieved the product 18. The sensor 30A, 30B, 30C, 30D may comprise a proximity sensor, a pressure sensor, a motion sensor, a force sensor, a contact sensor, a camera, and/or any other suitable component.

Each of the plurality of lockers 12 includes an indicator 32A, 32B, 32C, 32D that changes between a first visual representation and a second visual representation different from the first visual representation, as suggested in FIGS. 1-3. In some embodiments, the indicator 32A, 32B, 32C, 32D is located on the door 22A, 22B, 22C, 22D of the locker 12A, 12B, 12C, 12D.

In some embodiments, the plurality of lockers 12 are omitted and replaced with a vending machine. In such an embodiment, products 18 are stored in the vending machine. The vending machine includes a coil per each product 18 that is configured to vend the respective product 18. The controller 16 is configured to distribute the products 18 from the vending machine. To vend a product 18, the controller 16 determines a location of each product 18 within the vending machine and determines a pickup sequence. Based on the pickup sequence, the controller 16 spins the respective coil of the vending machine associated with the product 18 to vend the product 18. The vending machine may include a sensor, similar to the sensor 30A, configured to detect, determine, and/or indicate when the product 18 that was vended is removed from the vending machine such that the next product 18 may be vended.

In some embodiments, the retail kiosk system 10 includes one kiosk 14. In some embodiments, the retail kiosk system 10 includes two kiosks 14A, 14B, as shown in FIGS. 1-3. Though shown as including two kiosks 14A, 14B, the retail kiosk system 10 may include any number of kiosks 14. If there are multiple kiosks 14A, 14B, multiple users may interact with the retail kiosk system 10 simultaneously. Each kiosk 14A, 14B includes a user interface 34A, 34B and a scanner 36A, 36B, as shown in FIGS. 1-3. The user interface 34A, 34B and the scanner 36A, 36B are each in communication with the controller 16. The user interface 34A, 34B displays information for the user. The scanner 36A, 36B is configured to read a code, such as a barcode or a QR code. The barcode or the QR code may be on a printed purchase receipt or a digital purchase receipt. Because the kiosks 14A, 14B are self-service kiosks 14A, 14B, the retail kiosk system 10 may operate 24/7.

In some embodiments, each of the kiosks 14A, 14B includes a kiosk indicator 38A, 38B configured to change between a first visual representation and a second visual representation different from the first visual representation, as suggested in FIGS. 1-3. For example, in some embodiments, the first visual representation is an illuminated green light to indicate that the kiosk 14A, 14B is available for use by the user, as shown in FIG. 1. As another example, in some embodiments, the second visual representation is an illuminated red light to indicate that the kiosk 14A, 14B is unavailable for use by the user. In some embodiments, the second visual representation includes an illuminated yellow light. In some embodiments, the second visual representation is an unilluminated light (i.e., turning off the illuminated green light).

The controller 16 is configured to retrieve a product list based on the code scanned with the scanner 36A, 36B of the kiosk 14A, 14B. For example, the user can scan the code on a printed purchase receipt, and the controller 16 will retrieve the product list corresponding to the products 18 on the purchase receipt. The user can scan one or more codes with the scanner 36A, 36B. For example, the user can scan the code on a printed purchase receipt corresponding to products 18 purchased in-store and the user can scan a code on a digital purchase receipt corresponding to products 18 purchased online. In such a case, the controller 16 will retrieve the product list associated with both codes (i.e., the product list from multiple points of sale).

The controller 16 is also configured to retrieve an inventory list indicating the product 18 that is stocked in each of the plurality of lockers 12, along with a locker location of each of the plurality of lockers 12 within the pickup location. The controller 16 outputs a pickup sequence associated with the product list to be implemented by the plurality of lockers 12. One locker 12A, 12B, 12C, 12D of the plurality of lockers 12 is opened at a time. As such, the pickup sequence determines which locker 12A, 12B, 12C, 12D will be opened first, second, third, etc. The sequential disbursement of products 18 on the product list allows for safer vending as the subsequent product 18 will only vend if the prior product 18 has been successfully vended.

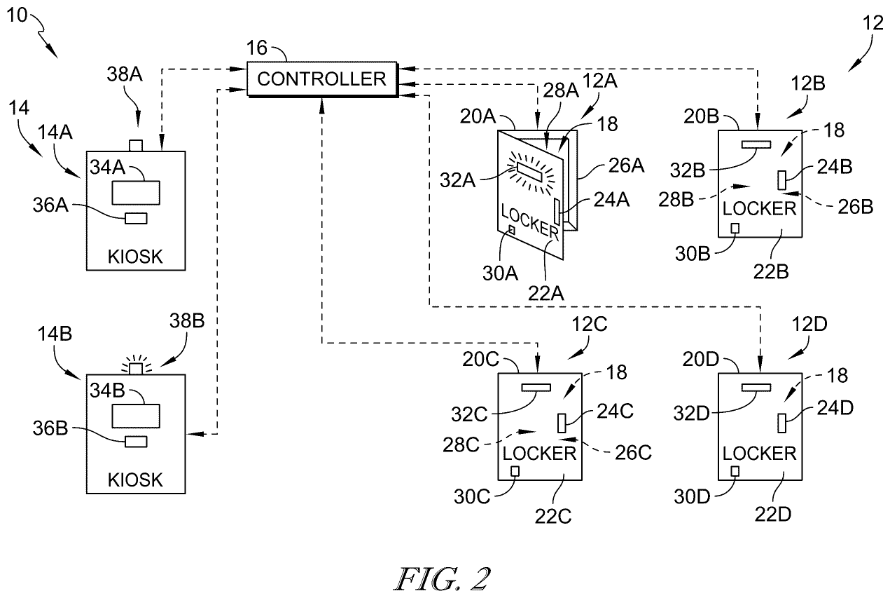

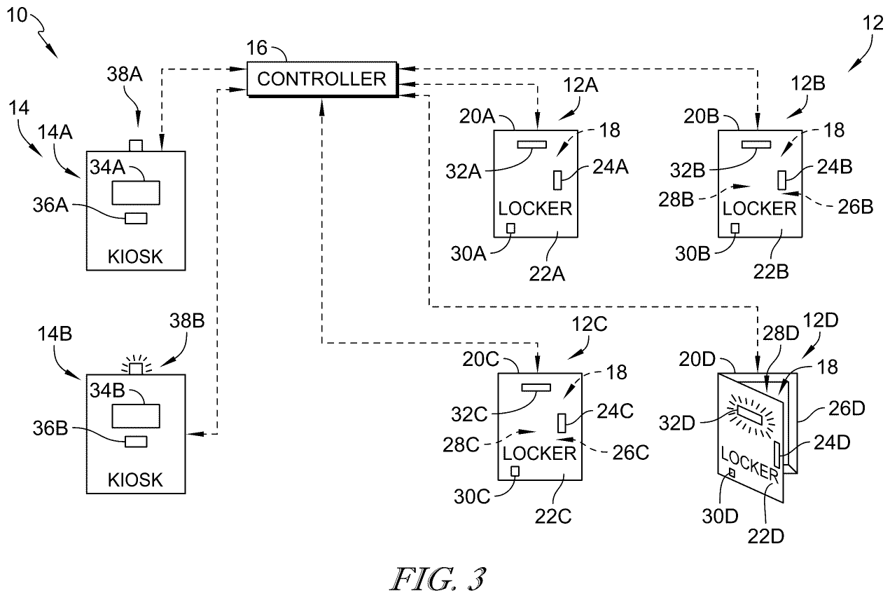

The pickup sequence is based, at least in part, on the locker location of each product 18 on the product list. For example, the controller 16 takes into account the locker location of each product 18 within the pickup location, a distance between the kiosk 14A, 14B and each locker location, and a distance between each of the locker locations. The controller 16 will optimize the pickup sequence, at least in part, based on these locker locations and distances. In doing so, the controller 16 minimizes backtracking of the user between different lockers 12A, 12B, 12C, 12D. For example, the first locker 12A included in the pickup sequence may be closer to the kiosk 14A, and the second locker 12D included in the pickup sequence may be farther away from the kiosk 14A as compared to the first locker 12A, as suggested in FIGS. 2-3.

The pickup sequence is also based, at least in part, on a category of each product 18 on the product list. For example, the controller 16 takes into account the category of each product 18, such as, but not limited to, a weight of each product 18, a size of each product 18, and a cost of each product 18. The controller 16 will optimize the pickup sequence, at least in part, based on at least one of these categories. In doing so, the controller 16, for example, allows the user to pick up lighter products 18 first, to pick up bulkier products 18 last, or to pick up more expensive products 18 last. The pickup sequence is optimized based on the locker location of each product 18 and the category of each product 18 on the product list thereby allowing the plurality of lockers 12 to be sequentially opened based on the pickup sequence. The optimization of the pickup sequence improves the efficiency, convenience, and safety of the retail kiosk system 10.

The controller 16 is configured to output the pickup sequence to the user interface 34A, 34B of the kiosk 14A, 14B so that the user is informed of the pickup sequence. In some embodiments, the controller 16 is configured to output a map of the plurality of lockers 12 on the user interface 34A, 34B, and the map indicates the pickup sequence thereon. For example, the map can label each locker 12A, 12B, 12C, 12D included in the pickup sequence with a number indicating which locker 12A, 12B, 12C, 12D is first, second, third, etc. in the pickup sequence. In some embodiments, the map indicates the product 18 that will be vended from each locker 12A, 12B, 12C, 12D included in the pickup sequence.

The retail kiosk system 10 is beneficial for purchasing of high-risk products 18 (i.e., relatively expensive products 18). For example, because the products 18 are stocked in the plurality of lockers 12, the products 18 experience less human interaction as the products 18 are placed in the lockers 12 and remain in the lockers 12 until vended via the retail kiosk system 10. The user may purchase the high-risk product 18 online or may take a placard or an item substitute to the register in the retail store for an in-store purchase. In doing so, the user does not interact with the high-risk product 18 until the high-risk product 18 is vended, and retail associates do not interact with the high-risk product 18 at all during the purchase.

A method 200 is provided herein. The method 200 includes step 202 of completing a purchase, which may be an in-store purchase, an online purchase, or a combination of the same. Once step 202 is complete, the retailer's systems and the retail kiosk system 10 are synced in step 204 to update inventory numbers of products 18. In step 206, the code (i.e., the barcode or the QR code) is produced, either on a printed purchase receipt or a digital purchase receipt for the user. In step 208, the user scans the code at the kiosk 14A, 14B via the scanner 36A, 36B. Also in step 208, the kiosk indicator 38A, 38B changes from the first visual representation, such as an illuminated green light, to the second visual representation, such as an illuminated red light, to indicate that the kiosk 14A, 14B is in use and unavailable to other users.

In step 210, the controller 16 verifies that a transaction related to the code exists. For example, the controller 16 verifies that the transaction related to the code has not already been vended and/or completed by the retail kiosk system 10. In step 212, the controller 16 retrieves the product list based on the code scanned via the scanner 36A, 36B. If multiple codes are scanned, the controller 16 retrieves the product list associated with each code. In step 214, the controller 16 retrieves an inventory list indicating the product 18 that is stocked in each of the plurality of lockers 12 and determines a locker location for each product 18 on the product list. In step 216, the controller 16 generates a pickup sequence. To generate the pickup sequence, the controller 16 considers the locker location of each product 18 on the product list and a category of each product 18 on the product list. In step 218, the controller 16 outputs and displays the pickup sequence on the user interface 34A, 34B of the kiosk 14A, 14B so the user is informed of the pickup sequence.

In step 220, the controller 16 transmits a signal to the lock 24A of the first locker 12A in the pickup sequence to release the door 22A from the body 20A of the first locker 12A such that the user can access the product 18 within the first locker 12A, as shown in FIG. 2. Also in step 220, the indicator 32A of the first locker 12A changes to the first visual representation, such as an illuminated light, to help direct the user to the first locker 12A. In step 222, the controller 16 determines if the product 18 has been removed from the first locker 12A via the sensor 30A. For example, the controller 16 can determine that the product 18 was removed based on a weight change within the first locker 12A. As another example, the controller 16 can determine that the product 18 was removed due to the user securing the door 22A to the body 20A of the first locker 12A.

After the controller 16 determines that the product 18 was removed from the first locker 12A, the method 200 proceeds to step 224. In step 224, the controller 16 determines if there are additional products 18 on the product list to vend. If there are additional products 18 on the product list that have not yet been vended, the method 200 proceeds back to step 220, as previously described. In step 220, the controller 16 transmits a signal to the lock 24D of the second locker 12D in the pickup sequence to release the door 22D from the body 20D of the second locker 12D such that the user can access the product 18 within the second locker 12D, as suggested in FIG. 3. Also in step 220, the indicator 32A of the first locker 12A changes to the second visual representation, such as an unilluminated light, and the indicator 32D of the second locker 12D changes to the first visual representation, such as an illuminated light, to help direct the user from the first locker 12A to the second locker 12D.

In step 222, the controller 16 determines if the product 18 was removed from the second locker 12D via the sensor 30D. After the controller 16 determines that the product 18 was removed from the second locker 12D, the method 200 proceeds to step 224. In step 224, the controller 16 determines if there are additional products 18 on the product list that have not yet been vended. If there are additional products 18 on the product list, the method 200 proceeds back to step 220, as previously described. If there are no additional products 18 on the product list to be vended, meaning that all products 18 on the product list have been vended to the user, the method 200 proceeds to step 226. In step 226, the transaction is retired and marked as complete by the controller 16 such that the code is no longer usable. Also in step 226, the kiosk indicator 38A, 38B changes from the second visual representation, such as an illuminated red light, to the first visual representation, such as an illuminated green light, to indicate that the kiosk 14A, 14B is no longer in use and available to other users.

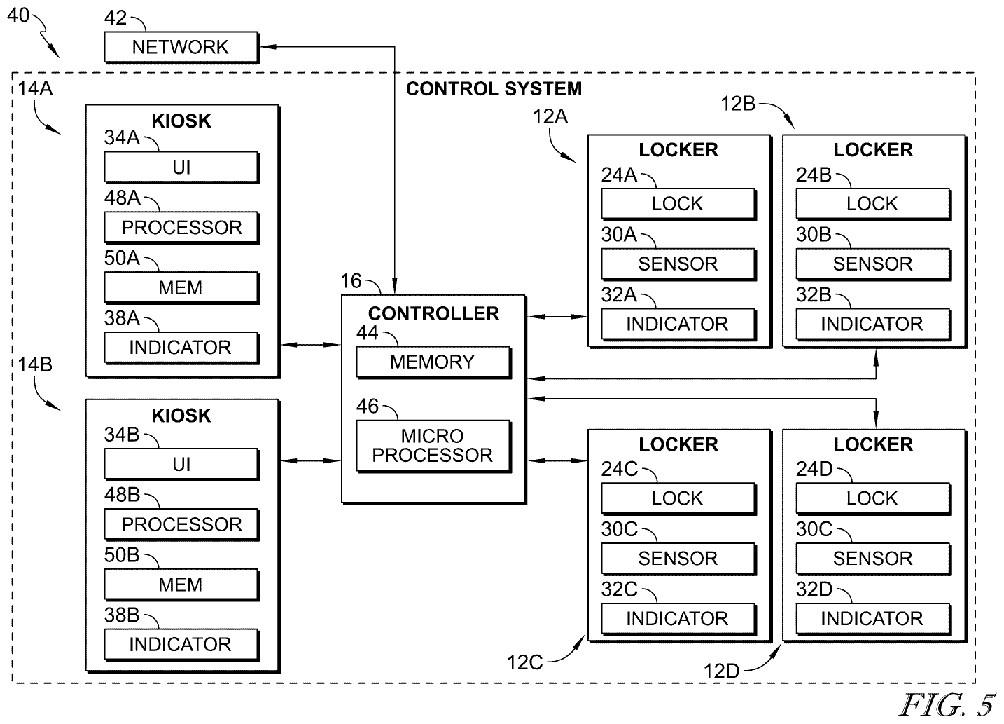

Illustratively, the controller 16 is included in a control system 40 as shown in FIG. 5. The controller 16 is in communication with a network 42, such as a point of sale (POS) system and/or an inventory control system. In some embodiments, the controller 16 may be integrated into one or more of the kiosks 14A, 14B. In some embodiments, the controller 16 may be integrated into traditional point of sale (POS) systems and inventory control systems via REST API. Because the controller 16 is integrated with or in communication with the POS system and/or inventory control system of the retailer, the controller 16 cooperates with the retailer's other systems to track inventory levels. As such, the retailer may be notified when products 18 are running low such that restock is initiated. Further, the integration of or communication between the retailer's systems and the controller 16 ensures that products 18 are not oversold, thereby reducing the risk of inventory shortages.

The controller 16 includes a memory 44 and a microprocessor 46 as shown in FIG. 5. The memory 44 includes instructions stored therein that are executable by the microprocessor 46 to cause the microprocessor 46 to implement portions of the method 200. The controller 16 is in communication with the kiosks 14A, 14B and each of the lockers 12A, 12B, 12C, 12D.

The control system 40 includes a microprocessor 48A, 48B for each of the kiosks 14A, 14B and a memory 50A, 50B for each of the kiosks 14A, 14B as shown in FIG. 5. The scanned code(s) are stored in the memory 50A, 50B of the kiosk 14A, 14B and communicated to the controller 16. The microprocessor 48A, 48B of the kiosk 14A, 14B directs the kiosk indicator 38A, 38B to change between the first visual representation and the second visual representation.

The scanned code(s) are stored in the memory 44 of the controller 16. The memory 44 also stores the inventory list indicating the product 18 that is stocked in each of the plurality of lockers 12, along with the locker location of each of the plurality of lockers 12 within the pickup location. The microprocessor 46 determines the pickup sequence and communicates the pickup sequence to the kiosks 14A, 14B so that the pickup sequence is displayed on the user interface 34A, 34B of the kiosks 14A, 14B.

The lock 24A, 24B, 24C, 24D of each of the plurality of lockers 12 is configured to release the door 22A, 22B, 22C, 22D from the body 20A, 20B, 20C, 20D in response to a signal received from the microprocessor 46 of the controller 16. The microprocessor 46 of the controller 16 also receives data from the sensor 30A, 30B, 30C, 30D regarding the locker 12A, 12B, 12C, 12D (i.e., whether the product 18 is still in the locker 12A, 12B, 12C, 12D). The microprocessor 46 communicates with the indicator 32A, 32B, 32C, 32D of each of the lockers 12A, 12B, 12C, 12D to change the indicator 32A, 32B, 32C, 32D between the first visual representation and the second visual representation.

Although this disclosure refers to specific embodiments, it will be understood by those skilled in the art that various changes in form and detail may be made without departing from the subject matter set forth in the accompanying claims.

1. A method of operating a retail kiosk system comprising:
providing a plurality of lockers and at least one kiosk in communication with each of the plurality of lockers, each of the plurality of lockers including a product therein;
retrieving a product list based on at least one code scanned by the at least one kiosk;
determining a locker location of each product on the product list;
generating a pickup sequence associated with the product list based,
at least in part, on the locker location of each product on the product list and, at least in part, on a category of each product on the product list;
based on the pickup sequence, opening a first locker of the plurality of lockers;
determining that the product in the first locker has been removed from the first locker; and
in response to determining that the product in the first locker has been removed, opening a second locker of the plurality of lockers.

2. The method of claim 1, further comprising displaying the pickup sequence on a user interface of the at least one kiosk.

3. The method of claim 1, wherein the step of opening a first locker includes changing a first indicator included on the first locker to a first visual representation from a second visual representation different than the first visual representation to indicate that the first locker is open.

4. The method of claim 3, wherein the step of opening a second locker includes changing the first indicator included on the first locker to the second visual representation and changing a second indicator included on the second locker to a third visual representation from a fourth visual representation different than the third visual representation to indicate that the second locker is open.

5. The method of claim 1, further comprising determining that the product in the second locker has been removed from the second locker, and in response to determining that the product in the second locker has been removed, opening a third locker of the plurality of lockers.

6. The method of claim 1, wherein the category of each product includes at least one of a weight, a size, and a cost.

7. The method of claim 1, wherein the step of retrieving a product list based on at least one code includes retrieving the product list based on two different codes.

8. The method of claim 1, further comprising changing a kiosk indicator included on the at least one kiosk to a first visual representation from a second visual representation different than the first visual representation to indicate that the at least one kiosk is available for use.

9. The method of claim 8, wherein the first visual representation is an illuminated green light.

10. A point of delivery retail kiosk system for vending products comprising:
a plurality of lockers, each of the plurality of lockers including a body formed to include an aperture opening into an interior product storage region, a door coupled to the body to close the aperture, and a lock configured to release selectively the door from the body to open the aperture, each of the plurality of lockers containing a product therein,
at least one kiosk including a user interface and a scanner configured to scan at least one code, and
a controller in communication with each of the plurality of lockers and the at least one kiosk, the controller configured to retrieve a product list based on the at least one code scanned by the scanner of the at least one kiosk and output a pickup sequence associated with the product list to be implemented by the plurality of lockers, the pickup sequence based, at least in part, on a locker location of each product on the product list and, at least in part, on a category of each product on the product list so that the pickup sequence is optimized based on the locker location of each product and the category of each product on the product list thereby allowing the plurality of lockers to be sequentially opened based on the pickup sequence in an optimized manner.

11. The system of claim 10, wherein the controller is configured to determine the locker location of each product on the product list for use in determining the pickup sequence.

12. The system of claim 10, wherein each of the plurality of lockers includes a sensor in communication with the controller and configured to indicate when the product in the respective locker is removed from the respective locker.

13. The system of claim 12, wherein each of the plurality of lockers associated with the pickup sequence are opened sequentially such that a second locker of the plurality of lockers is not opened until the sensor of a first locker in the plurality of lockers indicates that the product in the first locker is removed from the first locker.

14. The system of claim 10, wherein the pickup sequence is displayed on the user interface of the at least one kiosk.

15. The system of claim 10, wherein each of the plurality of lockers includes an indicator that changes between a first visual representation and a second visual representation different than the first visual representation.

16. The system of claim 15, wherein the first visual representation is an illuminated light.

17. The system of claim 10, wherein the category of each product includes at least one of a weight, a size, and a cost.

18. The system of claim 10, wherein the at least one kiosk includes a kiosk indicator that changes between a first visual representation and a second visual representation different than the first visual representation to indicate that the at least one kiosk is available or unavailable for use.

19. The system of claim 18, wherein the first visual representation is an illuminated green light.

20. The system of claim 10, wherein the lock of each of the plurality of lockers is configured to release the respective door from the respective body in response to a signal received from the controller to allow a user to access the interior product storage region.

21. A controller comprising:
a processor, and
a memory having instructions stored therein executable by the processor to cause the processor to (a) retrieve a product list based on at least one scanned code, (b) determine a location of each product on the product list, (c) determine a pickup sequence associated with the product list, the pickup sequence based, at least in part, on the location of each product on the product list and, at least in part, on a category of each product on the product list, and (c) output the pickup sequence.

22. The controller of claim 21, wherein the instructions stored in the memory further include instructions executable by the processor to cause the processor to control a plurality of lockers such that the plurality of lockers are sequentially opened based on the pickup sequence in an optimized manner.

23. The controller of claim 22, wherein the instructions stored in the memory further include instructions executable by the processor to cause the processor to open a first locker of the plurality of lockers based on the pickup sequence.

24. The controller of claim 23, wherein the instructions stored in the memory further include instructions executable by the processor to cause the processor to determine that the product in the first locker has been removed from the first locker.

25. The controller of claim 24, wherein the instructions stored in the memory further include instructions executable by the processor to cause the processor to, in response to determining that the product in the first locker has been removed, open a second locker of the plurality of lockers.
